(19) United States
(12) Patent Application Publication
(10) Pub. No.: US 2008/0012284 A1
(43) Pub. Date: Jan. 17, 2008

(54) Motorized retractor

(75) Inventors: Koji Inuzuka, Tokyo (JP); Koji Tanaka, Tokyo (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 11/812,318

(22) Filed: Jun. 18, 2007

(30) Foreign Application Priority Data
Jul. 12, 2006 (JP) 2006-191588

(51) Int. Cl. B60R 22/34

(52) U.S. Cl. 280/807

(57) ABSTRACT

An apparatus is provided to facilitate the electrical connection between a harness assembly and a motor-side terminal strip and the operation of assembling the harness assembly so as to improve the operating efficiency. A terminal assembly is formed by supporting terminals of a harness assembly to predetermined positions of a motor cap. The terminal assembly is fitted and attached to a motor body, thereby automatically and electrically connecting the terminals to corresponding motor-side terminal strips of the motor body. Therefore, there is provided a facilitated electrical connection of the harness assembly to the motor body.

### BACKGROUND

The present invention relates to the technical field of a seat belt retractor and apparatus having a spool that is rotated by an electric motor to wind and unwind a seat belt. Particularly, the present invention is related to a motorized retractor and seatbelt apparatus in which a motor-side terminal strip and a harness assembly are easily electrically connected.

Vehicles such as automobiles are equipped with seat belt apparatuses. In the event of an emergency, such as a vehicle collision, a seat belt apparatus restrains an occupant with a seat belt so as to prevent the occupant from jumping out of the seat, thereby protecting the occupant. The seat belt apparatus is provided with a seat belt retractor for winding the seat belt. In the seat belt retractor, the seat belt is fully wound onto a spool when the seat belt is not in use and the seat belt is withdrawn to be worn by the occupant when the seat belt is in use. In the event of an emergency as mentioned above, a locking means of the seat belt retractor is actuated to block a rotation of the spool in the belt unwinding direction, thereby preventing the withdrawal of the seat belt. In this manner, the seat belt restrains the occupant to protect the occupant in the event of an emergency.

A conventional seat belt apparatus is known which comprises a motorized retractor as a seat belt retractor of which rotation of a spool is controlled by an electric motor to wind and unwind a seat belt (see, for example, JP-A-2005-319995 and JP-A-2006-15916).

In the conventional motorized retractor, a harness assembly as power supply cables for supplying power to the motor and motor-side terminal strips are electrically connected by a connecting method such as spot welding or soldering, but not directly disclosed in the aforementioned patent documents JP-A-2005-319995 and JP-A-2006-15916.

The electric motor used in the motorized retractor is required to protect its motor body from water and dust. Typically, in the electric motor used in the conventional motorized retractor, the motor body is covered by a motor cover, whereby the motor body is protected from water and dust.

Further, the electric motor is required to prevent the harness assembly from being disengaged from the motor-side terminal strip and coming off the motor cover when the harness assembly is pulled. Typically in the electric motor used in the conventional motorized retractor, the electrical motor is provided with a holder and the harness assembly is wound around the holder, whereby the harness assembly is prevented from coming off the motor-side terminal strip when pulled.

However, it is not easy to electrically connect the harness assembly and the motor-side terminal strip by the connecting method such as spot welding or soldering as mentioned above. In addition, the operation is complex and operating efficiency is thus poor. Since the motor cover covering the motor body is used only for protecting the motor body from water and dust, the motor cover is not necessarily used effectively. Further, the assembly operation of the electric motor is complex because the harness assembly is wound around the holder in order to prevent the harness assembly from coming off the motor-side terminal strip when the harness assembly is pulled.

Accordingly, a motorized retractor is needed in which operation for electrically connecting a harness assembly and a motor-side terminal strip and operation for assembling the harness assembly are facilitated so as to provide improved operating efficiency and in which the motor cover of the motorized retractor are effectively used.

### SUMMARY

According to one embodiment, a motorized retractor includes a spool for winding up a seat belt, and an electric motor for rotating the spool, wherein the electric motor includes at least: a motor body for outputting rotation driving force, a harness assembly having terminals to be electrically connected to motor-side terminal strips of the motor body and a motor cover for the motor body, wherein electrical power is supplied to the motor body via the harness assembly, wherein the harness assembly is assembled to the motor cover such that the terminals are supported at predetermined positions of the motor cover, and wherein when the motor cover is attached to the motor body, the terminals are electrically connected to the motor-side terminal strips.

According to another embodiment, a seat belt apparatus for restraining an occupant with a seat belt includes a motorized retractor, having a spool that is rotated by an electric motor to wind and unwind the seat belt, a tongue slidably supported by the seat belt unwound from the motorized retractor, and a buckle to which the tongue is detachably latched.

According to still another embodiment, the motorized retractor of the seat belt apparatus includes a spool for winding up a seat belt, and an electric motor for rotating the spool, wherein the electric motor includes at least: a motor body for outputting rotation driving force, a harness assembly having terminals to be electrically connected to motor-side terminal strips of the motor body and a motor cover for the motor body, wherein electrical power is supplied to the motor body via the harness assembly, wherein the harness assembly is assembled to the motor cover such that the terminals are supported at predetermined positions of the motor cover, and wherein when the motor cover is attached to the motor body, the terminals are electrically connected to the motor-side terminal strips.

It is to be understood that both the foregoing general description and the following detailed description are exemplary and explanatory only, and are not restrictive of the invention as claimed.

### BRIEF DESCRIPTION OF THE DRAWINGS

Features, aspects and advantages of the present invention will become apparent from the following description, appended claims, and the accompanying exemplary embodiments shown in the drawings, which are briefly described below.

FIG. 1 shows a seat belt apparatus with a motorized retractor according to one embodiment.

FIG. 2 shows a motorized retractor according to one embodiment.

FIG. 3 is an exploded perspective view of an electric motor used in the motorized retractor shown in FIG. 1, according to one embodiment.

FIG. 4 is a left side view showing a motor cap of the electric motor shown in FIG. 1, according to one embodiment.

FIG. 5 is a left side view showing a terminal stopper of the electric motor shown in FIG. 1, according to one embodiment.

FIG. 6 is a perspective view showing a terminal assembly of the electric motor shown in FIG. 1, according to one embodiment.

FIG. 7 shows an electric connection between a motor-side terminal strip of the electric motor and a terminal shown in FIG. 1, according to one embodiment.

### DETAILED DESCRIPTION

Embodiments of the present invention will be described below with reference to the accompanying drawings. It should be understood that the following description is intended to describe exemplary embodiments of the invention, and not to limit the invention.

To solve the aforementioned problems, a motorized retractor is provided that comprises at least a spool for winding up a seat belt, and an electric motor for rotating the spool, wherein the electric motor includes at least a motor body for outputting rotation driving force, a harness assembly having terminals to be electrically connected to motor-side terminal strips of the motor body and a motor cover for the motor body, wherein electrical power is supplied to the motor body via the harness assembly, wherein the harness assembly is assembled to the motor cover such that the terminals are supported at predetermined positions of the motor cover, and wherein when the motor cover is attached to the motor body, the terminals are electrically connected to the motor-side terminal strips.

According to another embodiment, the motor cover comprises a motor cover member and a motor cap and the terminals are supported at predetermined position of the motor cap.

According to yet another embodiment, the motor body is formed to have an outer surface with a circular or substantially circular cross section and the motor cap is formed to be cylindrical or substantially cylindrical, and the motor cap is positioned relative to the motor body in the circumferential direction and is fitted to the motor body.

According to still another embodiment, the motor cap is provided with terminal supporting portions, each formed in a U-like shape with an opening formed in one end thereof for supporting the terminals and wherein the terminals are supported by the terminal supporting portions and the terminal stoppers are positioned adjacent to the openings.

According to another embodiment, a motor seal ring is arranged between the motor body and the motor cap.

According to yet another embodiment, a seat belt apparatus for restraining an occupant with the seat belt comprises at least: a motorized retractor of which spool is rotated by an electric motor to wind and unwind a seat belt, a tongue slidably supported by the seat belt unwound from the motorized retractor, and a buckle to which the tongue is detachably latched.

According to the motorized retractor and the seat belt apparatus, having the arrangement as mentioned above, the terminals can be automatically and electrically connected to the motor-side terminal strips when the motor cover on which the terminals of the harness assembly are supported at the predetermined positions is attached to the motor body. Therefore, this arrangement requires neither spot welding nor soldering conventionally required, thereby facilitating the electrical connection of the harness assembly to the motor body. Accordingly, the time for assembling the motor body can be reduced, thereby improving the operating efficiency and reducing the manufacturing cost.

Further, when at least one of the motor body and the harness assembly fails or is damaged, the motor body and the harness assembly can be separated from each other and the failed or damaged component can be replaced with a new one. Therefore, the motor-side terminal strips and the terminals are automatically and electrically connected, thereby easily assembling the normal electric motor. Accordingly, since the motor cover is used for electrical connection between the terminals of the harness assembly and the motor-side terminal strips, the motor cover is effectively utilized.

According to another embodiment, the terminals are positioned relative to and supported by the motor cap and the motor cap is also positioned relative to and fixed to the motor body, thereby smoothly achieving a stable electric connection between the terminals and the corresponding motor-side terminal strips of the motor body.

According to still another embodiment, the terminals are positioned relative to and supported by the U-like terminal supporting portions of the motor cap and the terminal stopper are positioned adjacent to the openings of the terminal supporting portions, thereby preventing the terminals from coming off the terminal supporting portions when the harness assembly is pulled. Moreover, the prevention of the terminals from coming off can be achieved only by attaching and supporting the terminal stopper to the motor cap, thereby facilitating the operation of assembling the harness assembly.

Further, according to another embodiment, since the motor seal ring is arranged between the motor body and the motor cap, foreign matter such as water and dust is effectively prevented from invading the inside of the motor cap from the outside of the motor cap and, for example, from reaching the electric connecting portion between the motor-side terminal strips of the electric motor and the terminals, even though the motor cover is formed of two separate members, i.e. the motor cap and the motor cover member.

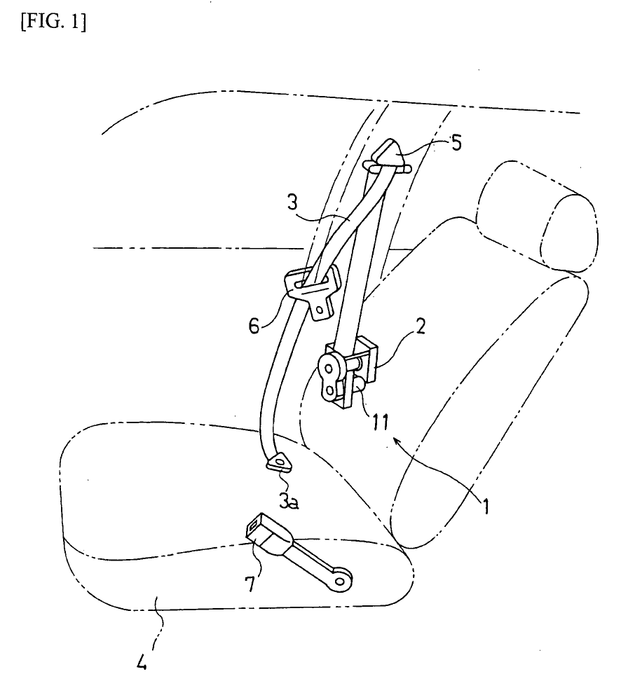

FIG. 1 is an illustration schematically showing a seat belt apparatus with an embodiment of a motorized retractor according to one embodiment. As shown in FIG. 1, the seat belt apparatus 1 of this embodiment comprises, similarly to a conventionally-known three-point type seat belt apparatus using a motorized retractor, a motorized retractor 2 fixed to a vehicle body, a seat belt 3 which is withdrawn from the motorized retractor 2 and is provided at an end thereof with a belt anchor 3a which is fixed to a floor of the vehicle body or a vehicle seat 4, a deflection fitting 5 for guiding the seat belt 3, withdrawn from the motorized retractor 2, to a shoulder of an occupant, a tongue 6 which is slidably supported on the seat belt 3 guided by the deflection fitting 5, and a buckle 7 which is fixed to the floor of the vehicle body or the vehicle seat 4 and into which the tongue 6 is detachably inserted.

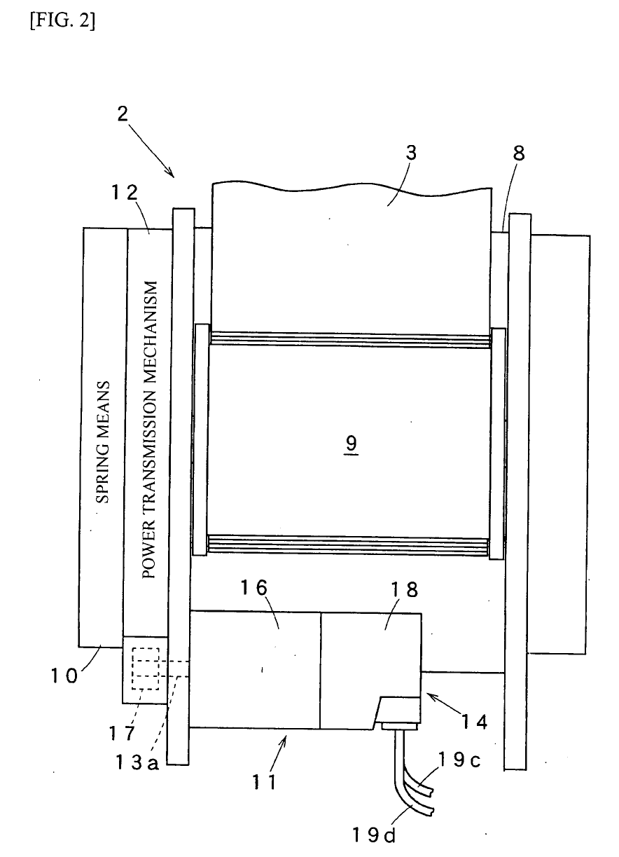

As shown in FIG. 2, the motorized retractor 2, according to one embodiment, comprises, similarly to a conventionally-known motorized retractor, a frame 8 having a U-like shape, the seat belt 3, a spool 9 which is rotatably supported by the frame 8 for winding up the seat belt 3, a spring means 10 which is supported by the frame 8 for always biasing the spool 9 in the winding direction, an electric motor 11 as a driving means which is supported by the frame 8 for rotating the spool 9, and a power transmission mechanism 12 which is supported by the frame 8 for transmitting the power of the electric motor 11 to the spool with changing the rotation speed. The electric motor 11 is controlled by a controller (CPU) (not shown), thereby controlling the rotation of the spool 9.

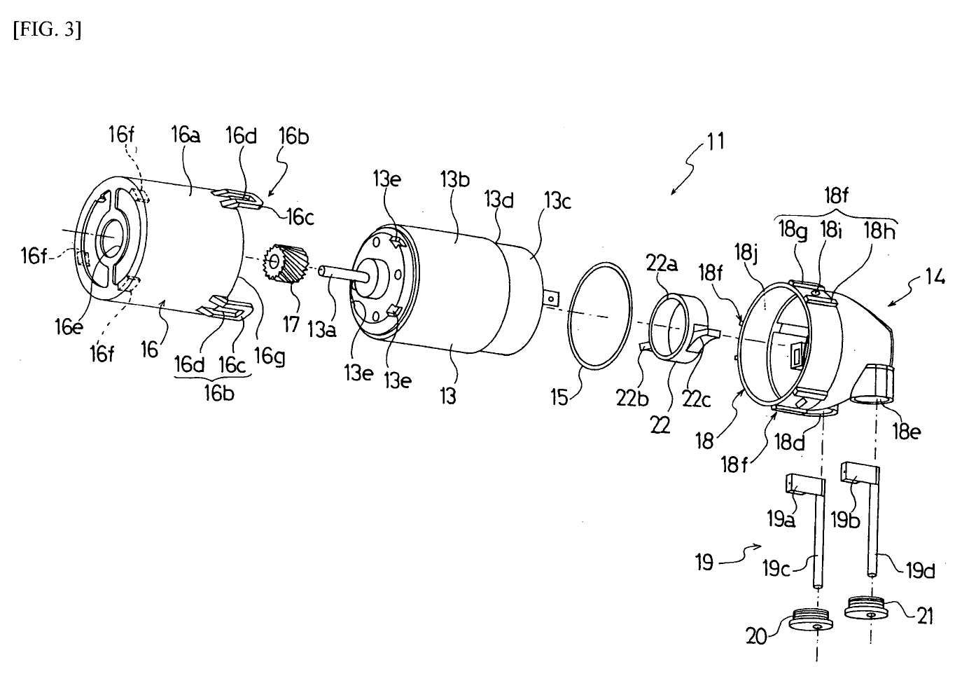

According to one embodiment, the electric motor 11 used in the motorized retractor 2 of this embodiment has the following structure. That is, as shown in FIG. 3, the electric motor 11 comprises a motor body 13 having an outer surface of which cross section is circular or substantially circular, a terminal assembly 14, a motor seal ring 15, a motor cover member 16, and a motor gear 17.

The motor body 13 generates rotational driving force and outputs the rotational driving force through the motor gear 17 attached to a rotation shaft 13a thereof. The rotation of the motor gear 17 is transmitted to the spool 9 with changing the rotation speed by the power transmission mechanism 12. The motor body 13 is formed to have a stepped shape in its outer surface, comprising a large-diameter portion 13b, a small-diameter portion 13c, and a step 13d between the large-diameter portion 13b and the small-diameter portion 13c. On an end of the large-diameter portion 13b of the motor body 13 on the rotation shaft 13a side, a predetermined number (three in the illustrated example) of positioning concavities 13e are disposed at regular intervals in the circumferential direction. The terminal assembly 14 comprises a motor cap 18, a harness assembly 19, a pair of grommets 20, 21 which are conventionally known, and a terminal stopper 22.

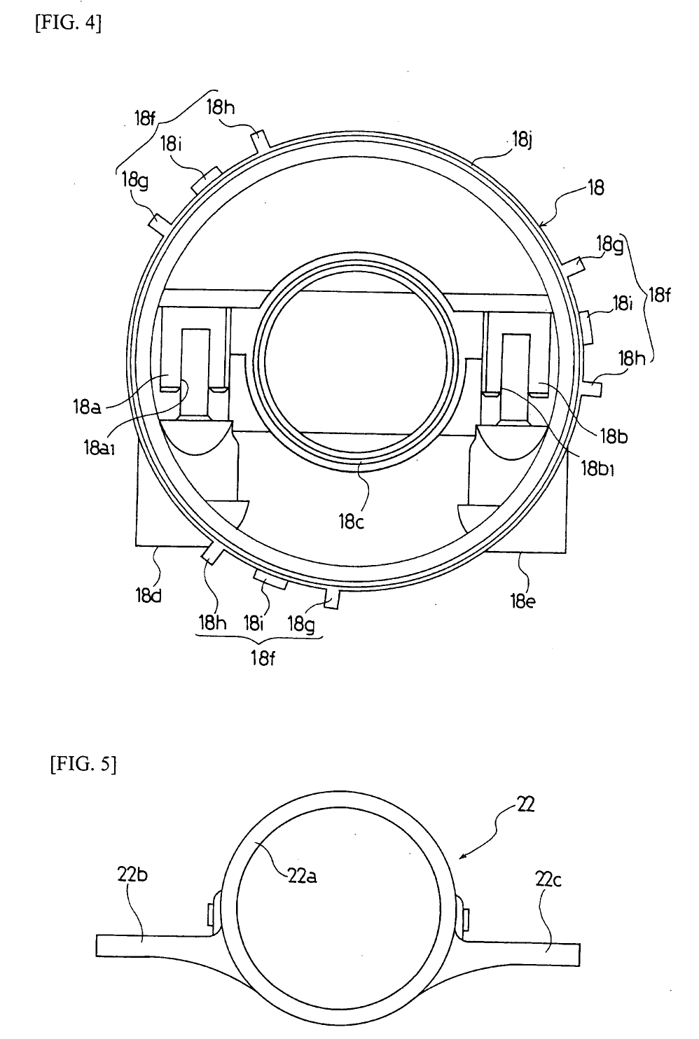

As shown in FIGS. 3 and 4, the motor cap 18 is formed in a bottomed cylindrical shape or a bottomed general cylindrical shape. At predetermined positions inside the motor cap 18, a pair of U-like terminal supporting portions 18a, 18b having openings 18a₁, 18b₁ formed in one end thereof respectively are disposed symmetrically about a line passing the center of the cylinder of the motor cap 18. Inside the motor cap 18, a terminal stopper mounting portion 18c having a bottomed cylindrical shape is also disposed to project in the same direction as the axial direction of the motor body 13. The motor cap 18 is further provided with a pair of harnesses through holes 18d, 18e. On the outer surface of the motor cap 18, a predetermined number (three in the illustrated example) of receiving portions 18f are arranged at predetermined intervals (regular intervals in the illustrated example) in the circumferential direction. Each receiving portion 18f comprises a pair of guiding portions 18g, 18h and an engaging projection 18i formed between the guiding portions 18g and 18h. The harness assembly 19 comprises a pair of power supply cables 19c, 19d which are provided at their front ends with terminals 19a, 19b, respectively. Power is supplied to the motor body 13 via the harness assembly 19.

As shown in FIG. 5, the terminal stopper 22 comprises an annular mounting portion 22a which is detachably fitted and attached to the terminal stopper mounting portion 18c of the motor cap 18, and a pair of arm-like terminal retaining portions 22b, 22c which are attached to the mounting portion 22a, respectively. As a method for detachably fitting and attaching the mounting portion 22a to the terminal stopper mounting portion 18c, a conventionally known method may be employed. Accordingly, a description of the method is omitted.

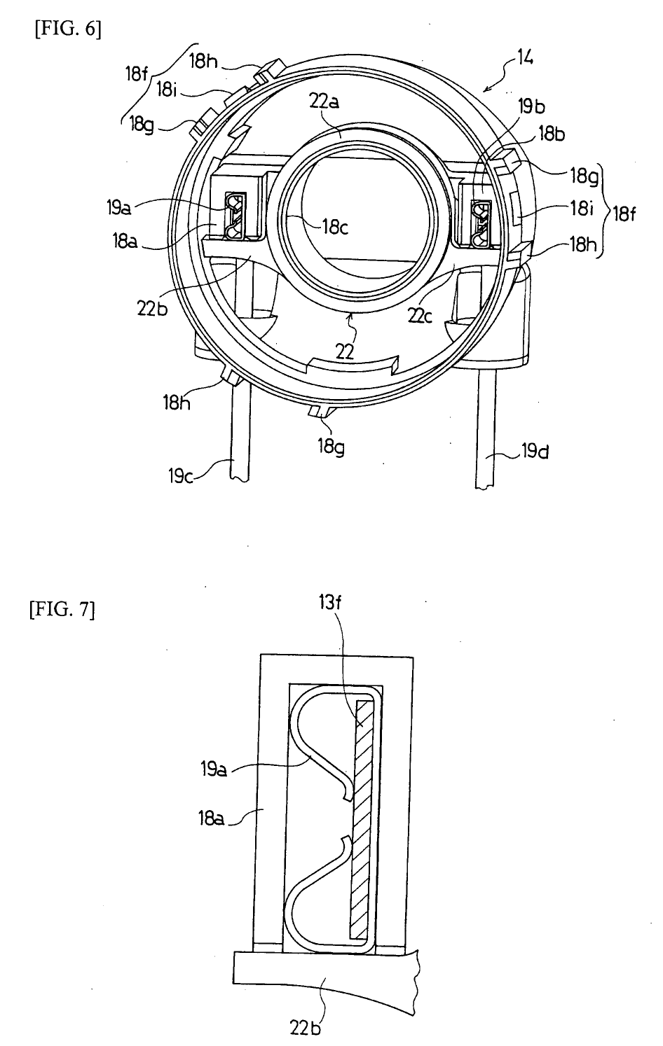

Description will now be made as regard to the assembly operation of the terminal assembly 14 of this embodiment having the structure mentioned above. As shown in FIG. 6, the terminals 19a, 19b are accommodated in and supported by the corresponding terminal supporting portions 18a, 18b of the motor cap 18. That is, both the terminals 19a, 19b are supported at the predetermined positions of the motor cap 18. Then, the mounting portion 22a of the terminal stopper 22 is detachably fitted and attached to the terminal stopper mounting portion 18c of the motor cap 18 such that the terminal retaining portions 22b, 22c are positioned adjacent to the openings 18a₁, 18b₁ of the corresponding terminal supporting portions 18a, 18b, respectively. The terminals 19a, 19b accommodated in the respective terminal supporting portions 18a, 18b are prevented from coming off the terminal supporting portions 18a, 18b by the terminal retaining portions 22b, 22c.

The power supply cables 19c, 19d extending from the respective terminals 19a, 19b extend from the inside to the outside of the motor cap 18 passing through the harness through holes 18d, 18e. In this case, the grommets 20, 21 are attached to the harness through holes 18d, 18e such that the power supply cables 19c, 19d pass through the grommets 20, 21. The inside of the motor cap 18 is liquid-tightly sealed from the outside by the grommets 20, 21, thereby preventing foreign matter such as water and dust from invading the inside of the motor cap 18 from the outside of the motor cap 18.

In this manner, the terminal assembly 14 is assembled. Though the power supply cables 19c, 19d are inserted through the harness through holes 18d, 18e after the terminals 19a, 19b are accommodated in and supported by the terminal supporting portions 18a, 18b in the aforementioned assembling method of the terminal assembly 14, the power supply cables 19c, 19d may be inserted through the harness through holes 18d, 18e before the terminals 19a, 19b are accommodated in and supported by the terminal supporting portions 18a, 18b.

According to one embodiment, the motor cover member 16 has a cover body 16a having a bottomed cylindrical shape. The cover body 16a is provided on its outer surface with a predetermined number (three in the illustrated example) of engaging portions 16b which are arranged at predetermined intervals (regular intervals in the illustrated example) in the circumferential direction to correspond to the receiving portions 18f of the motor cap 18, respectively. Each engaging portion 16b comprises an engaging member 16c which is formed in a U-like shape to project in the axial direction of the cover body 16a and which is made of an elastic material. The cover body 16a and the engaging members 16c cooperate together to form an engaging hole 16d. Formed in the bottom of the cover body 16a is a hole 16e through which the rotation shaft 13a and the motor gear 17 are passed. The cover body 16a is further provided on its inner surface with a predetermined number (three in the illustrated example) of positioning projections 16f which are arranged at predetermined intervals (regular intervals in the illustrated example) in the circumferential direction to correspond to the positioning concavities 13e of the large-diameter portion 13b of the motor body 13.

Hereinafter, the assembly operation of the electric motor 11 of this embodiment will be described. As shown in FIG. 3, the motor cover member 16 is fitted onto the motor body 13 from the large-diameter portion 13b side in the axial direction until the bottom of the motor cover member 16 comes in contact with the end of the large-diameter portion 13b. During this, the positioning projections 16f of the cover body 16a are fitted in the corresponding positioning concavities 13e of the motor body 13, thereby positioning the motor cover member 16 relative to the motor body 13 in the circumferential direction.

Then, the motor seal ring 16 is fitted onto the small-diameter portion 13c of the motor body 13 and the terminal assembly 14 which is assembled in the aforementioned manner is also fitted onto the small-diameter portion 13c. During this, the terminal assembly 14 is moved until the engaging members 16c of the motor cover member 16 are guided by the corresponding pairs of the guiding portions 18g, 18h so as to run over the engaging projections 18i because the engaging members 16c elastically bend and then return its original state because of the elastic returning force. When the engaging members 16c return its original state, the engaging projections 18i are inserted into the corresponding engaging holes 16d, whereby the engaging member 16c are stopped from moving both in the axial direction and in the circumferential direction by the engaging projections 18i. Therefore, the motor cap 18 and the motor cover member 16 are fitted and attached to the motor body 13 and are prevented from coming off the motor body 13. That is, the motor cap 18 and the motor cover member 16 form a motor cover covering the motor body 13.

When the motor cap 18 of the terminal assembly 14 is fitted to the motor body 13, the motor seal ring 15 is caught between the outer surface of the small-diameter portion 13c of the motor body 13 and the inner surface 18j of the motor cap 18. The space between the outer surface of the motor body 13 and the inner surface 18j of the motor cap 18 is liquid-tightly sealed by the motor seal ring 15, thereby preventing foreign matter such as water and dust from invading the inside of the motor cap 18 from the outside of the motor cap 18 and, for example, from reaching the electric connecting portion between the motor-side terminal strips of the electric motor 11 and the terminals 19a, 19b.

When the engaging member 16c is engaged with the engaging projection 18i as mentioned above, as shown in FIG. 7, a pair of terminals 19a, 19b of the terminal assembly 14 are automatically and electrically connected to corresponding motor-side terminal strips 13f attached to the motor body 13. (Though only the terminal 19a and the motor-side terminal strip 13f of one side are shown in FIG. 7, the other terminal 19b and the other motor-side terminal strip are structured the same.) In this case, the motor cover member 16 is positioned relative to the motor body 13 in the circumferential direction and the engaging member 16c of the motor cover member 16 is stopped from moving both in the axial direction and in the circumferential direction by the engaging projection 18i of the motor cap 18, whereby the motor cap 18 is positioned relative to the motor cover member 16 in the axial direction and the circumferential direction so that the terminal assembly 14 is positioned relative to the motor body 13 in the axial direction and the circumferential direction. Therefore, the electrical connection between the pair of terminals 19a, 19b and the motor-side terminal strips of the motor body 13 can be smoothly and stably achieved. In this manner, the electric motor 11 is assembled.

When at least one of the motor body 13, the terminal assembly 14, and the motor cover member 16 fails or is damaged, the motor body 13, the terminal assembly 14, and the motor cover member 16 can be separated from each other by cancelling the engagement between the engaging members 16c and the engaging projections 18i by the elastic bending of the engaging members 16c. After the failed or damaged one is replaced with a new normal one, the electric motor 11 is assembled in the aforementioned manner.

According to the motorized retractor 2 of this embodiment, the terminal assembly 14 is assembled by supporting the terminals 19a, 19b of the harness assembly 19 to the predetermined positions of the motor cap 18 and is fitted onto the motor body 13, thereby automatically and electrically connecting the terminals 19a, 19b to the corresponding motor-side terminal strips 13f of the motor body 13. Therefore, this arrangement does not require spot welding nor soldering conventionally required, thereby facilitating the electrical connection of the harness assembly 19 to the motor body 13. Accordingly, the time for assembling the electric motor 11 can be reduced, thereby improving the operating efficiency and reducing the manufacturing cost.

Further, the terminals 19a, 19b are positioned relative to and supported by the motor cap 18 of the terminal assembly 14 and the motor cap 18 is also positioned relative to and fixed to the motor body 13, thereby smoothly and stably achieving the electric connection between the terminals 19a, 19b and the corresponding motor-side terminal strips 13f of the motor body 13.

Further, the terminals 19a, 19b are positioned relative to and supported by the U-like terminal supporting portions 18a, 18b of the motor cap 18 and the terminal retaining portions 22b, 22c of the terminal stopper 22 are positioned adjacent to the openings 18a₁, 18b₁ of the terminal supporting portions 18a, 18b, thereby preventing the terminals 19a, 19b from coming off the terminal supporting portions 18a, 18b when the harness assembly is pulled. Moreover, the prevention of the terminals 19a, 19b from coming off can be achieved only by attaching and supporting the terminal stopper 22 to the terminal stopper mounting portion 18c of the motor cap 18, thereby facilitating the operation of assembling the harness assembly 19. Since the motor cap 18 of the motor cover is used for electrical connection between the terminals 19a, 19b of the harness assembly 19 and the motor-side terminal strips 13f, the motor cap 18 is effectively utilized.

Further, when at least one of the motor body 13, the terminal assembly 14, and the motor cover member 16 is failed or damaged, the motor body 13, the terminal assembly 14, and the motor cover member 16 can be separated from each other and the failed or damaged one can be replaced with a new normal one. Therefore, the motor-side terminal strips 13f and the terminals 19a, 19b are automatically and electrically connected, thereby easily assembling the normal electric motor 11.

Since the motor seal ring 15 is arranged between the motor cap 18 and the motor cover member 16, foreign matter such as water and dust is effectively prevented from invading the inside of the motor cover from the outside of the motor cover even though the motor cover is formed of two separate members, i.e. the motor cap 18 and the motor cover member 16. Moreover, the grommets 20, 21 are attached to the harness through holes 18d, 18e of the motor cap 18, thereby further effectively preventing foreign matter such as water and dust from invading the inside of the motor cover.

Though the pairs of the positioning concavities 13e and the positioning projections 16f, and the pairs of the engaging portions 16b and the receiving portions 18f are arranged in regular intervals in the circumferential direction, respectively in the aforementioned embodiment, the motorized retractor 11 of the present invention allows to arrange at least either the pairs of the positioning concavities 13e and the positioning projections 16f, or the pairs of the engaging portions 16b and the corresponding receiving portions 18f at nonregular intervals in the circumferential direction. According to this arrangement, the motor cover member 16 and the terminal assembly 14 can be prevented from being assembled with the motor body 13 in error with respect to the circumferential direction, thereby more smoothly achieving a stable electric connection between the terminals 19a, 19b and the motor-side terminal strips 13f. In case of providing three pairs or more of the positioning concavities 13e and the positioning projections 16f and three pairs or more of the engaging portion 16b and the receiving portion 18f, at least one of the intervals in the circumferential direction may be different from the other intervals in the circumferential direction and the other intervals in the circumferential direction may be set to be equal.

The above-described embodiments has several advantages. For example, the motorized retractor and the seat belt apparatus are suitably used to a motorized retractor as a seat belt retractor of which spool is rotated by an electric motor to wind and unwind a seat belt and a seat belt apparatus employing the same.

Japan Priority Application 2006-191588, filed Jul. 12, 2006 including the specification, drawings, claims and abstract, is incorporated herein by reference in its entirety.

The foregoing description of a preferred embodiment of the invention has been presented for purposes of illustration and description. It is not intended to be exhaustive or to limit the invention to the precise form disclosed, and modifications and variations are possible in light of the above teaching or may be acquired from practice of the invention. The embodiment was chosen and described in order to explain the principles of the invention and as a practical application to enable one skilled in the art to utilize the invention in various embodiments and with various modification are suited to the particular use contemplated. It is intended that the scope of the invention be defined by the claims appended hereto and their equivalents.

What is claimed is:

1. A motorized retractor comprising:
a spool for winding up a seat belt, and an electric motor for rotating the spool, wherein the electric motor includes at least:
a motor body for outputting rotation driving force;
a harness assembly having terminals to be electrically connected to motor-side terminal strips of the motor body; and
a motor cover for the motor body, wherein electrical power is supplied to the motor body via the harness assembly, wherein the harness assembly is assembled to the motor cover such that the terminals are supported at predetermined positions of the motor cover, and wherein when the motor cover is attached to the motor body, the terminals are electrically connected to the motor-side terminal strips.

2. A motorized retractor as claimed in claim 1, wherein the motor cover comprises:
a motor cover member; and
a motor cap, wherein the terminals are supported at predetermined position of the motor cap.

3. A motorized retractor as claimed in claim 2, wherein the motor body is formed to have an outer surface with a circular or substantially circular cross section, the motor cap is formed to be cylindrical or substantially cylindrical, and wherein the motor cap is positioned relative to the motor body in a circumferential direction and is fitted to the motor body.

4. A motorized retractor as claimed in claim 2, wherein the motor cap is provided with terminal supporting portions which are each formed in a U-like shape with an opening formed in one end thereof for supporting the terminals and wherein the terminals are supported by the terminal supporting portions and the terminal stoppers are positioned adjacent to the openings.

5. A motorized retractor as claimed in claim 2, wherein a motor seal ring is arranged between the motor body and the motor cap.

6. A seat belt apparatus for restraining an occupant with a seat belt comprising:
a motorized retractor, having a spool that is rotated by an electric motor to wind and unwind the seat belt;
a tongue slidably supported by the seat belt unwound from the motorized retractor, and
a buckle to which the tongue is detachably latched.

7. A seat belt apparatus as claimed in claim 6, wherein the motorized retractor comprises:
a spool for winding up a seat belt, and an electric motor for rotating the spool, wherein the electric motor includes at least:
a motor body for outputting rotation driving force;
a harness assembly having terminals to be electrically connected to motor-side terminal strips of the motor body; and
a motor cover for the motor body, wherein electrical power is supplied to the motor body via the harness assembly, wherein the harness assembly is assembled to the motor cover such that the terminals are supported at predetermined positions of the motor cover, and wherein when the motor cover is attached to the motor body, the terminals are electrically connected to the motor-side terminal strips.

8. A seat belt apparatus as claimed in claim 7, wherein the motor cover comprises:
a motor cover member; and
a motor cap, wherein the terminals are supported at predetermined position of the motor cap.

9. A seat belt apparatus as claimed in claim 8, wherein the motor body is formed to have an outer surface with a circular or substantially circular cross section, the motor cap is formed to be cylindrical or substantially cylindrical, and wherein the motor cap is positioned relative to the motor body in a circumferential direction and is fitted to the motor body.

10. A seat belt apparatus as claimed in claim 8, wherein the motor cap is provided with terminal supporting portions which are each formed in a U-like shape with an opening formed in one end thereof for supporting the terminals and wherein the terminals are supported by the terminal supporting portions and the terminal stoppers are positioned adjacent to the openings.

11. A seat belt apparatus as claimed in claim 8, wherein a motor seal ring is arranged between the motor body and the motor cap.
